(19) United States
(12) Patent Application Publication
(10) Pub. No.: US 2025/0252806 A1
(43) Pub. Date: Aug. 7, 2025

(54) PARCEL LOCKER BANK SYSTEM WITH BANKS OF LOCKERS WITH REAR SIDE ACCESS

(71) Applicant: QUADIENT TECHNOLOGIES FRANCE, Bagneux (FR)

(72) Inventor: Stéphane Pointeau, Cavaillon (FR)

(21) Appl. No.: 19/042,288

(22) Filed: Jan. 31, 2025

(30) Foreign Application Priority Data
Feb. 1, 2024 (EP) 24305183

(51) Int. Cl. G07F 17/12; A47G 29/14; G07C 9/00

(52) U.S. Cl. CPC G07F 17/13; A47G 29/141; G07C 9/00896; A47G 2029/149; G07C 2009/0092

(57) ABSTRACT

A parcel locker bank system for dispatching and collecting shipments by agents, and dropping-off and picking-up of shipments by users, including: a bank of lockers comprising a front side, a rear side, a control unit, a user interface facing on the front side, each locker comprising a compartment opened on the rear side of the bank, closed on the front side of the bank by an individual electronically controlled door, a remote shipping system comprising a Parcel Handling application communicates with the bank via a first long-distance communication network, and with a mobile device of the agent via a second long-distance communication network. The Parcel Handling application is operable to send data to the mobile device of the agent to guide the agent through the dispatching and collecting from the rear side and to receive data from the mobile device to verify that the agent has made no mistake.

### FIELD OF THE INVENTION

The present invention relates to systems and methods for dispatching shipments into electronic parcel locker banks including lockable compartments, and for picking-up these shipments thereafter.

### PRIOR ART—BACKGROUND OF THE INVENTION

Parcel locker bank systems are used for dispatching, storing, and picking up various kinds of shipments such as parcels or packages. A parcel locker bank comprises a series of lockers, synonymously referred to herein and in the clams as compartments, with different sizes, which are equipped with electronically controlled doors.

These parcel locker bank systems are used by carrier agents or other agents to dispatch shipments, which are then picked-up from the lockers by recipients, i.e., generally customers of businesses sending the shipments. When a shipment is not picked up in due time by the recipient, it needs to be collected by the carrier agents so that the lockers can be accessible for other shipments.

Locker banks are conveniently used in residential apartment complexes or university campuses where shipments and mail are handled by a mailroom clerk or a concierge. Shipments can be delivered to the mailroom clerk, who then dispatches the shipments into the lockers of the bank of lockers.

Usually, the parcel locker bank provides a user interface for the carrier agents and for the recipients. This user interface allows the user to enter information for operating the parcel locker bank and allows the parcel locker bank to provide information back to the user.

Known parcel locker bank systems have several issues. When shipments are dispatched into the different lockers of a bank, the user interface of the parcel locker bank can be monopolized by the carrier agent, thus blocking any recipients from picking-up shipments. For example, during peak hours on university campuses, students may be blocked for a long time if they happen to come to pick-up a shipment at the same time as a carrier agent dispatches all his new shipments (up to ½ hour or 1 hour), generating a waiting line of recipients. Providing a solution to allow dispatching and picking-up shipments in parallel would improve the user experience as recipients would not have to wait for the completion of the dispatch session. Another issue is that the architecture of prior art parcel locker bank system results in a time-consuming dispatch process as a new compartment door must be opened for any new shipment to be dispatched in a locker. Also, for tracking purposes, identification means in the form of a barcode label is affixed onto each shipment. The agent must capture the identification of each shipment either by entering it on the touch screen or by scanning the identification means affixed onto the shipment with a barcode reader integrated in the locker bank user interface before dispatching the shipment in a locker of the bank. This means that, after dispatching a shipment in a locker, the carrier agent must come back to the user interface of the locker bank to capture the identification of the next shipment to be dispatched.

### SUMMARY OF EMBODIMENTS OF THE INVENTION

A goal of at least some embodiments of the invention is to provide a parcel locker bank system allowing a carrier agent to dispatch and collect shipments from the lockers of a bank at the same time as some recipients pick up shipments already stored for them in the lockers of the bank.

A first aspect proposes a parcel locker bank system for dispatching and collecting shipments by an agent, as well as for dropping-off and picking-up of shipments by a user. The parcel locker bank system includes:
a bank of lockers comprising a front side, a rear side, a control unit, a user interface facing towards the front side of the bank, and several lockers extending each between said front side and said rear side of the bank and each configured to store a shipment, each locker comprising a compartment opened on the rear side of the bank, closed on the front side of the bank by an individual electronically controlled door,
a remote shipping system comprising a Parcel Handling application and communicating with the bank via a first long-distance communication network, and with a mobile device of the agent via a second long-distance communication network.

In a general aspect, the compartment of each locker is opened on the rear side of the bank, the bank being designed to give access to its rear side only to the agent while access to its front side is given to both the user and the agent, the control unit is configured to open the doors on the front side of the bank to allow dispatching, collecting, dropping-off and picking-up the shipments, and the parcel handling application is configured to send data to the mobile device of the agent to guide him through the dispatching and collecting of shipments from the rear side and to receive data from the mobile device of the agent to verify that the agent has made no mistake in dispatching and collecting.

The bank of parcel lockers can be installed through a wall of a mailroom so that the locker doors open onto a public area where recipients can pick-up their shipments and the rear side of the locker bank is only accessible from a restricted area of the mailroom. Thus, the agent can have access at the same time to all the lockers from the rear side of the bank while recipients can still access the lockers.

In a first embodiment of the invention, the parcel handling application can be configured to dispatch or collect a first shipment on the rear side of the bank while a second shipment is being picked-up from the front side of the parcel locker bank.

In particular the parcel handling application can be configured to send data to the control unit to allow a customer to pick-up a shipment from the front side of the bank even while an agent is dispatching or collecting shipments from the rear side of the bank.

In a second embodiment of the invention, the parcel handling application can be configured to disable access to the lockers from the front of the bank for a dispatch by a carrier agent or for a drop-off by the user while a shipment is being dispatched in the locker from the rear of the bank, and to disable access to the lockers from the front side of the bank for collecting a shipment by a agent while a shipment is collected from the rear of the bank.

In a third embodiment of the invention, the bank can comprise at least one standard locker equipped with an electronically controlled door attached on the front side of the bank and closed by a rear panel on the rear side of the bank, the standard locker being used for dispatching, collecting, dropping-off and picking-up shipments only from the front side of the bank, the Parcel Handling application being configured to always allow access to the standard locker from the front side of the bank while shipments are being dispatched and or collected from the rear side of the bank.

In a fourth embodiment of the invention, a locker identifier can be attached onto or next to the locker and an identification label of the shipment can be attached to the shipment, the parcel handling application being configured to request and receive from the mobile device of the agent a capture of the identification label and of the locker identifier, to store the capture of the identification label of the shipment in a first memory space of the remote shipping system and store the locker identifier in a second memory space of the remote shipping system, and to associate the first memory space with the second memory space.

In a fifth embodiment of the invention, the mobile device of the agent can comprise or be associated with a scanning component and can be configured to use the scanning component for capturing identification labels and locker identifiers.

In a sixth embodiment of the invention, the parcel handling application can be configured for requesting via an interface of the mobile device an identification of a site of the bank of lockers, an identification of the bank, the identification label of the shipment, the locker identifier associated with the shipment, and for sending the capture of the identification label of the shipment and the capture of the locker identifier.

In a seventh embodiment of the invention, the parcel handling application can be configured to generate an authorization code further to a dispatch of a shipment in the rear side of a locker of the bank, and send the authorization code to the control unit of the bank for storage in a local memory, the control unit being configured to grant access to a user to said locker to pick-up the shipment by comparing the authorization code stored in the local memory with credential provided by the user.

In an eighth embodiment of the invention, the mobile device of the agent can be configured to establish a communication with the remote shipping system and the parcel handling application is configured to exchange in real time with the mobile device of the agent through the first long-distance communication network while shipments are being dispatched and/or collected from the rear side of the bank.

In a ninth embodiment of the invention, the parcel handling application can be configured to store a list of shipments to collect in a memory of the remote shipping system.

In a tenth embodiment of the invention, the bank can comprise:
a rear-loading column with at least one locker opened on the rear side of the bank,
a rear-loading control column including the control unit and the user interface and at least one locker opened on the rear side of the bank, and
a standard column with at least one standard locker closed on the rear side of the bank by a rear panel.

In an eleventh embodiment of the invention, the rear side of the bank of lockers is closed by at least one rear-side door, said rear-side door having dimensions allowing to close at least two lockers on the rear side of the bank.

In another aspect of the invention is proposed a method using a parcel locker bank for dispatching, collecting, dropping-off and picking-up shipments, wherein the parcel locker bank has a front side and a rear side and comprises a user interface and at least a locker equipped with an electronically controlled door attached on the front side of the bank and opened on the rear side of the bank to provide access for a dispatch and a collection of a shipment from the rear side of the bank, wherein the parcel locker bank communicates with a remote shipping system via a first long-distance communication network and the remote shipping system communicates with a mobile device via second a long-distance communication network, wherein the parcel locker bank controls a dispatch, a collection, a drop-off or a pick-up on the front side by an agent or a user or a recipient using the user interface for interacting with the lockers bank, and wherein the remote shipping system partially controls the parcel locker bank and manages the dispatch or the collection from the rear side in the compartment by an agent via the mobile device.

In another aspect of the method according to the invention, the method can comprise:
choosing to dispatch the first shipment from the rear side of the bank using the mobile device as a local interface for the remote shipping system, and
dispatching the first shipment on the rear side of the parcel locker bank while picking-up a second shipment from the front side of the lockers bank.

In another aspect of the method according to the invention, the method can further comprising disabling access to the locker from the front side of the parcel locker bank for a dispatch by a carrier agent and for a drop-off by a user when dispatching of the shipment from the rear side of the parcel locker bank.

In another aspect of the method according to the invention, the method can further comprise capturing an identification label of the shipment, preferably by scanning the identification with a scanning component integrated with the mobile device.

In another aspect of the method according to the invention, the method can further comprise capturing a locker identifier of the locker, preferably by scanning the locker identifier with a scanning component integrated with the mobile device.

In another aspect of the method according to the invention, the method can further comprise:
dispatching on the rear side the shipment in the locker,
storing the captured identification of the shipment and the captured locker identifier in the remote shipping system, and
associating the stored identification of the shipment and the stored locker identifier

In another aspect of the method according to the invention, the method can further comprise
following the capture of the identification label of the shipment and the capture of the locker identifier, verifying whether a status of the locker is non-acceptable including non-acceptable status being soiled or dysfunctional or opened or full,
if the status of the locker is not non-acceptable, proposing on the mobile device to dispatch the shipment and store the dispatch, before completing the dispatch of the shipment, and
if the status of the compartment is non-acceptable, displaying an error on the mobile device.

In another aspect of the method according to the invention, the method can further comprise
following the dispatch of the shipment, generating by the remote shipping system an authorization code to be used by a user of the shipment for picking-up the shipment from the locker,
sending the authorization code to the parcel locker bank,
storing the authorization code in the lockers bank, and
validating an access request from the user based on the authorization code stored in the parcel locker bank.

In another aspect of the method according to the invention, the method can further comprise
choosing to collect from the rear side of the bank a first shipment from the locker using the mobile device as a local interface for the remote shipping system, and
picking-up from the front side of the bank a second shipment of the parcel locker bank while collecting the first shipment from the rear side of the parcel locker bank

In another aspect of the method according to the invention, the method can further comprise disabling access from the front of the parcel locker bank to the locker for a collection by an agent while a shipment is being collected from the rear side of the parcel locker bank.

For each carrier, a list of shipments to be collected is maintained in the remote shipping system and can be used by the agent during the shipments collection process.

In another aspect of the method according to the invention, the method can further comprise
selecting a carrier within a list of carriers displayed on the mobile device and stored in the remote shipping system,
displaying on the mobile device a list of shipments to collect stored in the remote shipping system and corresponding to the selected carrier,
capturing the identification label of the shipment to be collected, preferably by scanning the identification label with a scanning component integrated with the mobile device,
or alternatively capturing the locker identifier, preferably by scanning the locker identifier with the scanning component,
removing the shipment from the locker, and
stopping displaying the shipment in the list of shipments for collection on the mobile device.

In another aspect of the method according to the invention, the method can further comprise:
generating events related to the dispatch or the collection on the rear side,
storing the events in the remote shipping system
sending the events to the parcel locker bank, and
storing the events in the parcel locker bank
for accessing the remote shipping system via his mobile device (420), entering credentials of the agent on the mobile device,
automatically accessing the remote shipping system,
selecting a site on the mobile device within a list of sites where the agent operates, and
selecting a parcel locker bank on the mobile device within a list of parcel locker banks of the site.

The agent may be working on different sites having different parcel locker bank installed-site selection is provided to ease the selection of the parcel locker bank for an agent having access to multiple sites with multiple lockers banks by filtering the multitude of lockers banks with the site.

### BRIEF DESCRIPTION OF THE DRAWINGS

Other aspects, features and advantages of the teachings of various embodiments and implementations of the invention will become clearer to those ordinary skilled in the art upon review of the following description in conjunction with the accompanying drawings where:

FIG. 1 illustrates a view of a front side of a parcel locker bank suitable for implementing embodiments of the invention;

FIG. 2 illustrates a view of a rear side of the parcel locker bank of FIG. 1;

FIG. 3 illustrates a perspective view of the parcel locker bank of FIG. 1;

FIG. 4 illustrates a parcel locker bank system according to at least one implementation of the invention for operating multiple locker banks for dispatching, collecting, picking-up and dropping-off shipments;

FIG. 5 provides a perspective view of four rear-loading columns of at least one implementation of the invention assembled into two pairs of columns;

FIG. 6 provides a perspective view of the four rear-loading columns of FIG. 5 with column doors closed;

FIG. 7 illustrates a perspective view of a rear side of a parcel locker bank according to the invention with a rear-loading control column, three rear-loading columns and four standard columns;

FIG. 8 illustrates a perspective view of FIG. 7 with column doors closed;

FIG. 9 represents a flow diagram of a method of the invention relative to accessing to a parcel handling application;

FIG. 10 represents a flow diagram of a method of the invention relative to dispatching shipments in a parcel locker bank according to at least one implementation of the invention;

FIG. 11 represents a flow diagram of a method of the invention relative to collecting shipments from a parcel locker bank according to at least one implementation of the invention.

### DETAILED DESCRIPTION

In order to allow dispatching and picking-up shipments in parallel, a parcel locker bank according to at least one implementation of the invention provides access to shipments stored in the lockers of bank from the front side of the bank for pick-up and drop-off by recipients and provides access to the carrier agent from the rear side of the lockers bank for dispatching or collecting shipments.

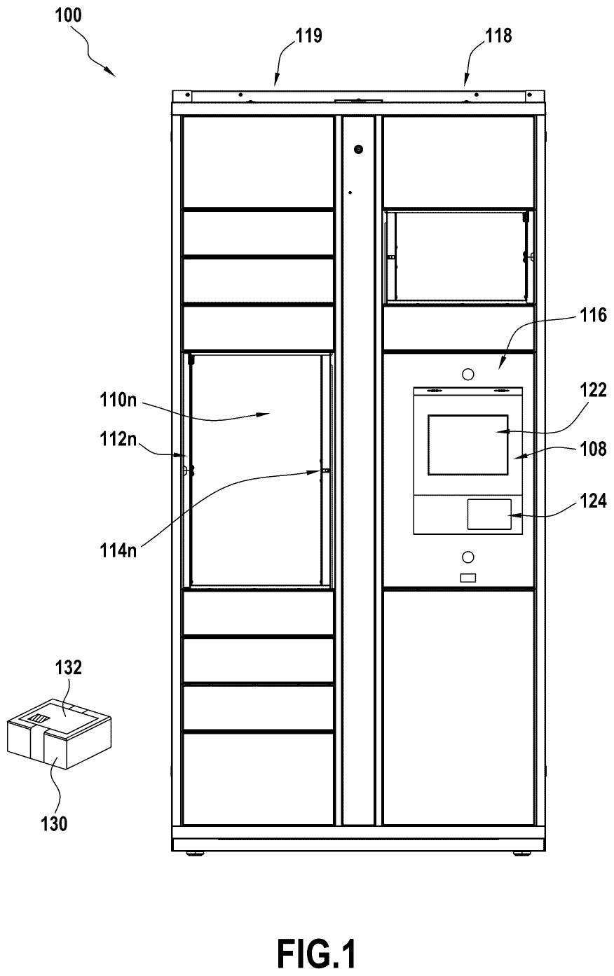

FIG. 1 illustrates a view of the front side of a parcel locker bank 100 according to at least one implementation of the invention. The parcel locker bank 100 comprises a control unit 116, a user interface 108 and a series of lockers, or compartments, 110n with different sizes.

Each locker 110n comprises an electronically controlled door 112n and an electrical lock 114n fastens or unfastens the door 112n. Preferably, the electrical lock 114n is installed along a side panel of the compartment 110n. Sensors may be provided for each compartment 110n for establishing the status of the electrical lock 114n (locked/unlocked) or the status of the door 112n (opened/closed) or whether the compartment 110n is empty or full. A visual indicator, such as a light emitting diode (LED), may be mounted onto each door 112n or next to each door 112n.

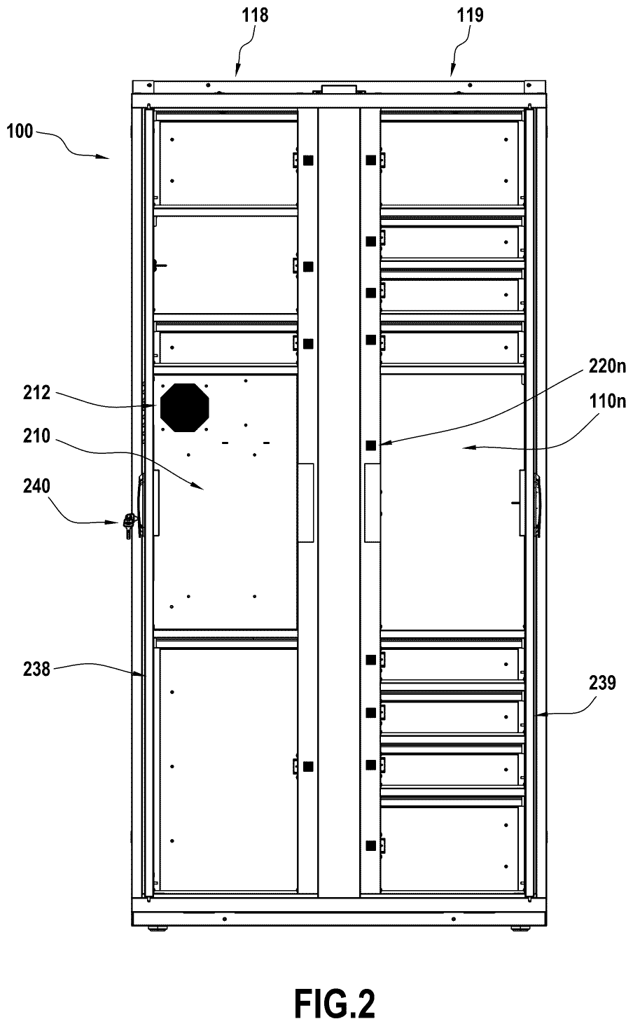

Each locker 110n is opened on the rear side of the bank 100, as illustrated in FIG. 2, and closed on the front side of the bank 100 as illustrated in FIG. 1.

The control unit 116 is configured to control the bank 100, for example for indicating which compartment should be used for dispatching or for picking-up a parcel. Preferably, when a door is unlocked, the door automatically opens, thanks for example to a spring mechanism, and therefore indicates which compartment 110n should be used without any need for a visual indicator.

Conveniently, the compartments 110n of a parcel locker bank 100 are assembled in columns with one of the columns including the control unit 116 and the user interface 108. FIG. 1 illustrates such an architecture with the bank 100 having two columns: a rear-loading control column 118, including the user interface 108 and the control unit 116, and a rear-loading additional column 119, including only lockers 110n. An objective of these columns is that shipments can be dispatched or collected from their rear side, therefore the naming of rear-loading control column and of rear-loading additional column, which will become clearer with the description of FIG. 2 below.

The parcel locker bank operation, and in particular the electrical locks 114n for opening or closing of the compartment doors, is controlled by the control unit 116 installed within the parcel locker bank behind the user interface 108. The control unit oversees the communication with the user interface 108, which preferably includes a touchscreen 122 and a barcode reader 124. In simpler configuration, the user interface can be limited to a keypad used to enter information.

When a carrier agent comes for dispatching shipments into parcel locker bank 100, the identification of each shipment 130 must be captured by the parcel locker bank and associated with the compartment where it is dispatched. For tracking purposes, an identification label 132 of the shipment 130, preferably in the form of a barcode printed on label, is affixed onto the shipment 130.

When a carrier agent performs the dispatch from the front side of the parcel locker bank 100, the capture of each shipment identification, i.e. the identification label 132, can be performed with the barcode reader 124 of the user interface 108.

The parcel locker bank system can also be used by a recipient for returning a shipment. The return shipment is then placed by the recipient in a compartment of the parcel locker bank and is collected later by a carrier agent and returned by the carrier. With the development of e-Commerce, there is a growing need for using parcel locker banks for direct sending of shipments. A typical use is for online sales, either for CtoC transactions or for sales from home businesses or small businesses. The sender directly dispatches his shipment in a compartment of a parcel locker bank, without the intervention of a carrier. The shipment is collected later by a carrier agent to bring to the final destination. Shipment drop-off in the form of a return or a direct sending by a user of parcel locker bank is a growing need for the parcel locker bank business.

FIG. 2 illustrates a view of the rear side of the bank 100 according to at least one implementation of the invention with a rear-loading control column 119 and a rear-loading additional column 118. Each locker 110n is made of two lateral sides and two horizontal top and bottom sides and is closed on the front side with the door 112n, and opened on the rear side of the bank 100. Horizontal top and bottom sides of locker 110n form shelves of a column as the lockers 110n are stacked onto each other. The lateral sides of the lockers are part of vertical side panels of the bank or of internal vertical panels. But each locker 110n has no rear side or rear panel so that it can be freely accessed from the rear side of the bank 100 so that shipments 130 can be dispatched or collected.

Only the space for the control unit 116 and the user interface 108 is protected by a rear panel 210 mounted on the rear-loading control column 119 and comprising a ventilating assembly 212, for cooling the control unit 116 and the user interface 108.

Each locker 110n is uniquely identified by a locker identifier 220n (synonymously referred to as compartment identifier) consisting preferably in a barcode associated with a number, which can be easily read by a user. Preferably, access from the rear side can be secured for appropriate personnel by large doors. In the embodiment illustrated in FIG. 2, the bank 100 comprises a column door 238 mounted on the rear side of the bank 100 and which can close the rear side of the column 118, and a column door 239 mounted on the rear side of the bank 100 and which can close the rear side of the column 119. Conveniently, each column door 238 and 239 can be locked with a key 240.

The bank 100 according to at least one implementation of the invention is particularly appropriate and convenient for university campuses with a mailroom. The lockers bank can be installed through a wall of the mailroom so that the compartment doors open onto a public area where students can pick-up their shipments and the rear side of the lockers bank is accessible from a restricted area of the mailroom. In such an embodiment, the bank does not need column doors on the rear side of the bank as the rear side is only accessible from a restricted room. Carrier agents bring the shipments to the mailroom and the mailroom clerk can then dispatch the shipments 130 from the interior of the mailroom through the rear side of the bank 100. As there are no compartment doors to be opened, the dispatch, as well as the collection, can be performed more efficiently.

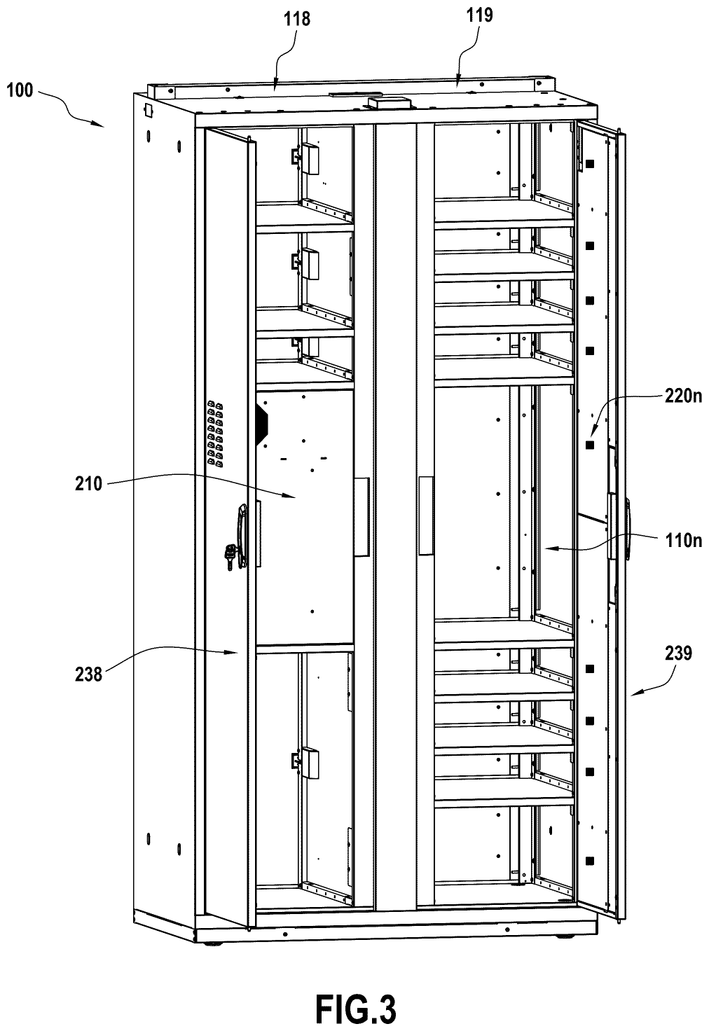

FIG. 3 provides a perspective view of the bank 100 of FIGS. 1 and 2. The column doors 238 and 239 are opened showing the interior of the lockers 110n. The rear-loading control column 119 comprises the control unit 116 and the user interface 108, which are protected by the only rear panel 210. In a particular embodiment of the invention, the locker identifier 220n is located on the internal side of the column doors.

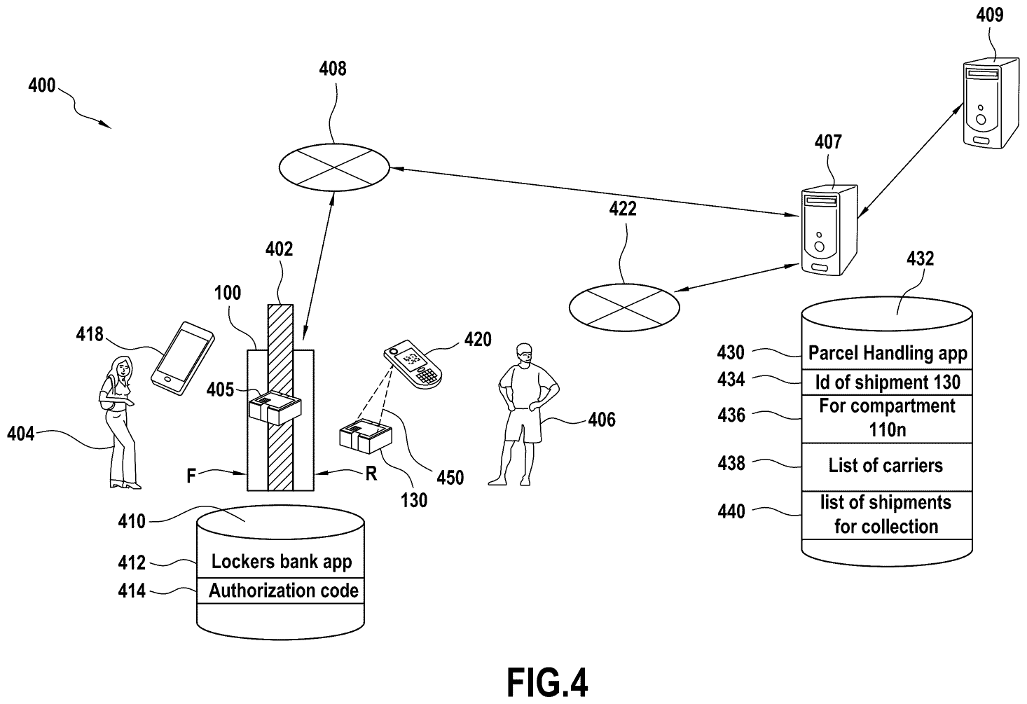

A parcel locker bank 100 according to at least one implementation of the invention is recommended when a loading area can be created behind the bank 100, for example in a mailroom. FIG. 4 illustrates a parcel locker banks system 400 according to at least one implementation of the invention for operating multiple parcel locker banks for dispatching, collecting, dropping-off and picking-up shipments 130.

The parcel locker bank 100 is installed through a wall 402 separating a public area, where a recipient 404 can pick-up a shipment 405, from a restricted area, for example a mailroom, where an agent 406 can dispatch shipments 130 and eventually collect shipments. The parcel locker bank 100 thus has its front side F located in the public area and its rear side R located in the restricted area. The agent 406, who can be a clerk in a university mailroom, a concierge in a residential apartment complex or a carrier agent, has access at the same time to all the compartments 110n from the rear side R of the bank 100. The parcel locker banks system 400 according to at least one implementation of the invention comprises, in addition to the bank 100, a remote shipping system 407, which manages authorization access to the bank 100 and data regarding the shipments handled by the bank 100. Data exchange between the bank 100 and the remote shipping system 407 is performed directly via a long-distance communication network 408 based on technologies such as 3G-4G or GSM. Electronic parcel locker bank systems generally comprise a park of lockers banks, all communicating with the remote central system in charge of managing the park of lockers banks. The remote shipping system 407 communicates with a carrier server system 409 and exchanges relative to shipments to be delivered or already delivered in locker banks. Locker banks can be dedicated to a specific carrier. But often they can be used by different carriers. The remote shipping system 407 can then be in communication with as many carrier server systems as the number of carriers using the park of lockers banks managed by the remote shipping system 407.

To pick-up a shipment, the recipient 404 is provided with a recipient code, which he communicates to the control unit 116 of the locker bank 100 for accessing a compartment 110n storing his shipment 130. The control unit 116 comprises a locker bank memory 410 storing a locker bank application 412 designed for operating the locker bank 100. The locker bank application is configured to request the recipient code from the recipient 404, to verify the code provided by the recipient 404 by comparing it with an authorization code 414 stored in the locker bank memory, and to control opening and closing of the different lockers 110n as well as the communication with the remote shipping system 407. The recipient 404 receives the recipient code on a mobile device 418 and enters the recipient code via the user interface 108. Alternatively, the mobile device 418 may be configured for communicating directly with the locker bank 100 via a short distance wireless communication network and for wirelessly providing the recipient code. The locker bank application is also configured to allow an agent to dispatch or collect shipments from the front side F of the bank 100. A carrier agent may choose to dispatch or collect shipments from the public area for example because he does not have access to the restricted area on the rear side R of the bank 100 or prefers not to use the rear side R.

To dispatch and collect shipments 130 from the rear side of the locker bank 100, the agent uses a mobile device 420, which can be a smartphone or a personal digital assistant (PDA) or an iPad or any computerized mobile device having some long-distance communication capabilities compatible with the long-distance communication capabilities of the remote shipping system 407. The mobile device 420 communicates with a remote shipping system 407 via a long-distance communication network 422 based on technologies such as 3G-4G or GSM, and which can be the same as the long-distance communication network 408. A Parcel Handling application 430 is installed on the remote shipping system 407 and is stored in a memory system 432 of the remote shipping system 407. The Parcel Handling application 430 is developed by the locker bank provider for managing the dispatch or collection of shipments via the rear side of the locker bank 100 and can be provided in the form of a web portal. The mobile device 420 of the agent 406 is configured for establishing a communication with the Parcel Handling application 430 during shipments dispatch or collection from the rear of the bank 100. A secured link for accessing the Parcel Handling application must be installed on the mobile device 420 and used by the agent for a dispatch or a collection of a shipment. The secured link, which can be a URL using the secured protocol HyperText Transfer Protocol Secure (HTTPS), is provided by the locker bank provider, and is preferably secured by a user login and a user password for limiting access to the Parcel Handling application. When the agent wants to dispatch or collect the shipment 130 in the locker 110n, he must first have his mobile device 420 accessing the Parcel Handling application 430 via the secured link. A communication session is opened between the mobile device 420 and the remote shipping system 407 and continuous exchanges are possible. Once the communication between the mobile device 420 and the Parcel Handling application 430 is established, the agent continues using the mobile device 420 as a local interface for the Parcel Handling application 430 during the whole dispatch process or a collection process. The session remains open during the whole dispatch process or a collection process, and may be terminated once a delay without activity is reached—the delay without activity being set at 1 or 2 hours for example. Once the agent has initiated a dispatch process or a collection process, the whole process is managed by the Parcel Handling application running on the remote shipping server 407 and exchanging with the mobile device 420 and with the agent 406 via the user interface of the mobile device 420.

When a shipment is dispatched or collected from the rear of the parcel locker bank 100, accessing the lockers from the front side at the same time may generate some difficulties. For example, when a carrier agent 406 interacts with the user interface 108 of the bank 100 for dispatching a shipment 130 from the front side of the bank, the control unit 116 opens an empty compartment, i.e. an empty locker 110n, and at the same time the agent 406 may decide to dispatch from the rear side a shipment 130 in the same compartment. Such occurrence may result in two shipments for different recipients being in the same compartment or complex errors to be solved. The technical solution for preventing such an issue is to have the Parcel Handling application 430 configured for disabling access from the front side of the bank 100 for a carrier agent 105 or a user (recipient or sender) 404 depending on the processes being performed with the parcel locker bank, when a shipment is being dispatched or collected from the rear of the parcel locker bank 100.

During a dispatch process from the rear side of the parcel locker bank, the Parcel Handling application 430 is configured to disable any access from the front side of the parcel locker bank 100 for a dispatch by a carrier agent 406 and for a drop-off by a user 404 (recipient or sender). During a collection process from the rear side of the parcel locker bank, the Parcel Handling application 430 is configured to disable access from the front side of the parcel locker bank for a collection by a carrier agent 406. As soon as a dispatch process or a collection process is initiated from the rear side of the parcel locker bank 100, the Parcel Handling application 430 sends a specific disabling message to the control unit 116 of the parcel locker bank 100 to block any inappropriate process relative to operations from the front side of the parcel locker bank. Thus, for a dispatch process from the rear side, the control unit 116 blocks any dispatch process and drop-off process from the front side. And, for a collection process from the rear side, the control unit 116 blocks any collection process from the front side. Therefore, when a shipment 130 is dispatched or collected from the rear side of the parcel locker bank 100, a user can still pick-up shipments from the front side of the parcel locker bank 100, but not drop-off a shipment, nor can another agent dispatch or collect shipments from the front side. In other words, the control unit 116 does not block a request for a pick-up made via the user interface 108.

More generally, the Parcel Handling application 430 can send command messages to the control unit 116 and perform some control on the parcel locker bank 100 such as blocking access to soiled or dysfunctional compartments, blocking access to a shipment for recipients and limiting access to restricted personnel or changing access rules.

The Parcel Handling application 430 is configured to request, via the interface of the mobile device 420, information related to the dispatch or collection including the selected process, an identification of the site where the parcel locker bank 100 is installed, an identification of the parcel locker bank 100, an identification of the shipment 130 captured during a dispatch or a collection, a locker identifier 220n (aka compartment identifier) captured during a dispatch or a collection or the carrier identification, so that an exact status of the parcel locker bank 100 can be maintained in the remote shipping system 407. Identification of the site may be redundant if it is included in the identification of the parcel locker bank, and it may not be used. Similarly, the carrier identification may be redundant if it is included in the identification of the shipment, and it may not be used. The Parcel Handling application 430 generates events associated with this information related to the dispatch or collection and with the interactions of the agent 406 with the Parcel Handling application 430 during the dispatch or collection, and stores these events in the memory system 432. Then, these events are provided to the parcel locker bank 100 by the Parcel Handling application 430 and stored in the parcel locker bank memory 410 so that an exact status of the parcel locker bank 100 can be maintained in the parcel locker bank memory 410 and so that the parcel locker bank application 410 is able to manage and control the parcel locker bank operation. All events generated during the dispatch or collection by the Parcel Handling application 430 and stored in the remote shipping system 407 are synchronized with parcel locker bank 100 for both parcel locker bank and remote shipping system to have the same information about parcels handled by the lockers bank.

For a dispatch process, the Parcel Handling application is configured for requesting the capture of the identification 132 of the shipment 130 and of the locker identifier 220n so that the shipment 130 can be associated with the compartment 110n in which it is dispatched. The captured identification 132 of the shipment 130 and the locker identifier 220n are communicated to the Parcel Handling application 430 and the identification of the shipment is stored in a memory 434 of the memory system 432 and associated, based on the received locker identifier 220n, with a memory 436 of the memory system 432 identifying the compartment 110n. In a preferred embodiment, a scanning component 450 is integrated with the mobile device 420 so that the agent 406 can scan the identification 132 of the shipment 130 and the locer identifier 220n. The scanning component 450 can be a dedicated internal scanner hardware integrated in the mobile device 420 or a camera installed in the mobile device 420, such as a camera in a smartphone, or an external handheld scanner connected to the mobile device 420, such as a handheld scanner connected to an iPad.

For a collection process, the Parcel Handling application is configured to request selecting a carrier corresponding to shipments to be collected. A list of carriers 438 authorized to use the parcel locker bank 100 is stored in the memory system 432. For each carrier of the list of authorized carriers, the Parcel Handling application 430 maintains a list of shipments 130 to collect stored in the memory system 432. As an illustration, a memory 440 of the memory system 432 stores a list of shipments to collect for a carrier of the list of authorized carriers.

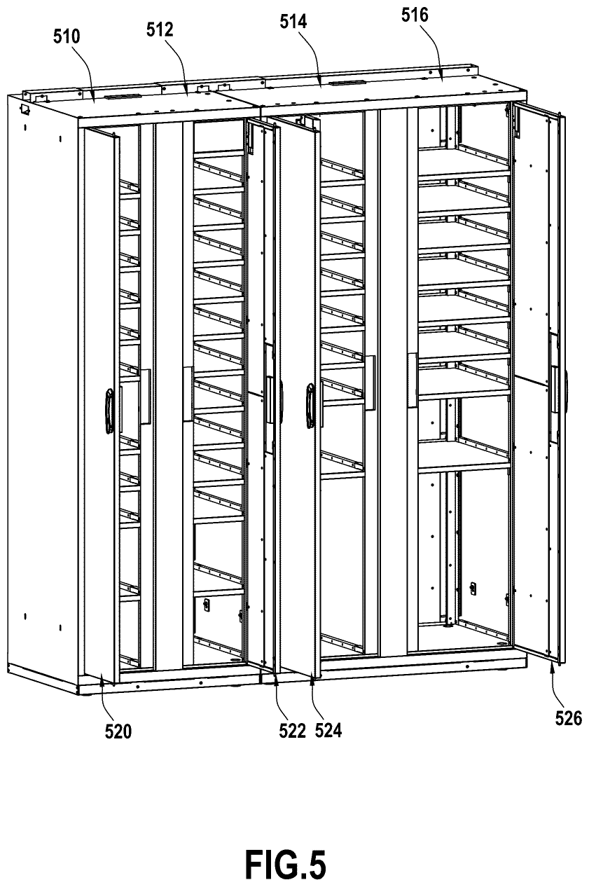

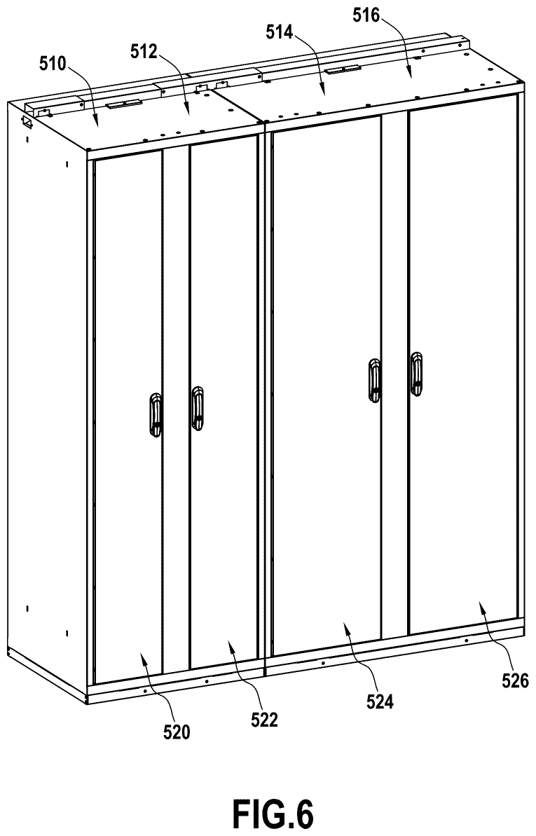

As illustrated in FIG. 1, a parcel locker bank 100 of at least one implementation of the invention includes preferably a rear-loading control column 118 comprising the control unit 116 and the user interface 108 and some compartments 110n, and rear-loading additional columns 119 comprising only compartments 110n. Conveniently, rear-loading additional columns 119 can be assembled in at least one pair of columns. FIG. 5 provides a perspective view of four rear-loading additional columns 510, 512, 514, 516 according to at least one implementation of the invention assembled into two pairs of columns. Two thinner rear-loading additional columns 510 and 512 are assembled into a thinner two column cupboard. Two wider rear-loading additional columns 514 and 516 are assembled into a wider two column cupboard. These rear-loading additional columns are displayed with their column doors 520, 522, 5224 and 526 opened. Rear-loading additional columns 510 to 516 can be assembled with a rear-loading control column 118 such as the one illustrated in FIG. 1 and connected with the control unit 118 of the rear-loading control column 118 either with electrical wires or with wireless connections. FIG. 6 provides a perspective view of the four rear-loading additional columns 510 to 516 assembled into two pairs of columns with their column doors 520, 522, 5224 and 526 closed.

According to an embodiment of the invention, standard additional columns 720, 722, 724, 726, i.e., columns of standard compartments 730n without rear access (with a rear panel blocking access to the compartments from the rear side), can be assembled with a rear-loading control column 118 in a similar manner as for the rear-loading additional columns 119.

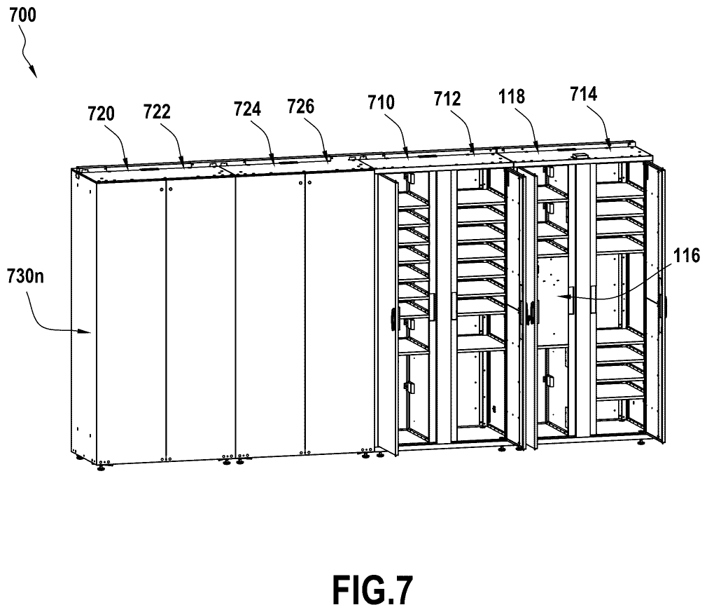

FIG. 7 illustrates a perspective view of the rear side of a parcel locker bank 700 of at least one implementation of the invention constituted of the rear-loading control column 118 assembled with three rear-loading additional columns 710, 712, 714, and with four standard additional columns 720, 722, 724 and 726. Each of the three rear-loading additional columns 710, 712, 714 and each of the four standard additional columns 720 to 726 is controlled by the control unit 116 of the rear-loading control column 118 and is connected with the control unit 116 either with electrical wires or with wireless connections.

When an agent 406 dispatches or collects a shipment 130 from the rear side of the parcel locker bank 100 or 700, the Parcel Handling application 430 is configured to disable any access from the front side of the parcel locker bank 100 for a carrier agent or a user (recipient or sender) to compartments of the rear-loading additional columns 710, 712 and 714 and to compartments of the rear-loading control column 118. However, a dispatch from the front of the parcel locker bank 700 into the standard additional columns 720, 722, 724 and 726 is not disabled, and a carrier agent can dispatch shipments 130 in any of the standard additional columns 720 to 726 at the same time as the agent 406 dispatches shipments 130 from the rear side of the parcel locker bank 700 into the rear-loading additional columns 710 to 716.

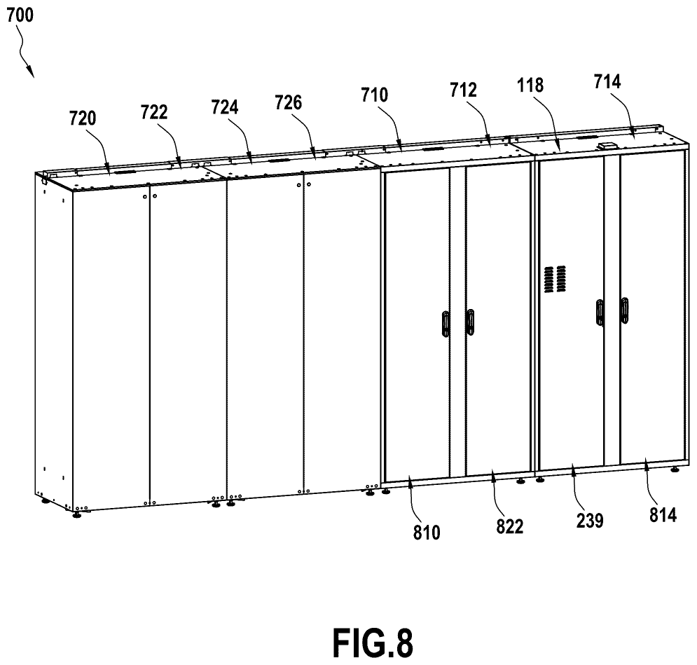

FIG. 8 illustrates a perspective view of the rear side of the parcel locker bank 700 with column doors 239, 810, 812, 814. In particular, FIG. 8 illustrates a parcel locker bank 700 where a column door 239 of the rear-loading control column 118 and each column door 810, 812, 814 of each of the three rear-loading additional columns 710, 712, 714 are closed. Such a mixed parcel locker bank configuration can by useful for example when the restricted area available for rear-loading the parcel locker bank is limited. The segment of the parcel locker bank constituted of the rear-loading control column 118 and the rear-loading additional columns 710, 712, 714 can be installed through a wall corresponding to the limited restricted area, and the segment of the parcel locker bank 700 comprising the standard additional columns (corresponding to 720, 722, 724 and 726 on FIG. 8) can be installed as an extension beyond the limited restricted area for supplementary storage capacity.

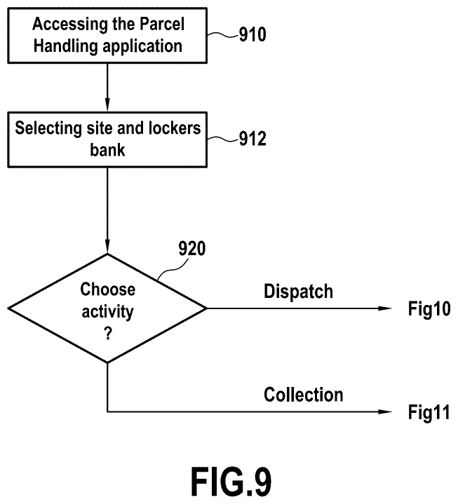

A method according to at least one implementation of the invention using the parcel locker banks system 400 including eventually a mixed parcel locker bank 700 is now described in reference to FIG. 9. To perform a dispatch process or a collection process from the rear side of a parcel locker bank 100 or 700, the agent 406 must first access the Parcel Handling application 430 via his mobile device 420. In act 910, the agent uses the mobile phone 420 to request access to the Parcel Handling application 430 and enters on the mobile device 420 his credentials, typically a login identification and a password. In a preferred embodiment, the mobile device 420 is dedicated for operating the parcel locker bank 100 or 700 from its rear side and may have been provided by the parcel locker bank provider. When the mobile device 420 is switched on, it automatically requests access to the Parcel Handling application 430, using for example a secured URL address of the Parcel Handling application running as a web portal on the remote shipping system 407. In another embodiment, the mobile device 420 is not dedicated to operating the parcel locker bank 100 or 700 and using the Parcel Handling application 430 to operate the parcel locker bank 100 or 700 is only one of the applications of the mobile device 420. The agent 406 can enter or select on the mobile device 420 a secured URL address of the Parcel Handling application running as a web portal on the remote shipping system 407. Once having accessed the Parcel Handling application 430, in act 912, at the request of the Parcel Handling application 430, via the interface of the mobile device 420, the agent selects the site where he operates and selects the parcel locker bank, which he wants to access. The agent may be working on different sites having different parcel locker bank installed. If the agent works on only one site and/or operates on only one parcel locker bank, no selection is requested. The site selection is provided to ease the selection of the parcel locker bank for an agent having access to multiple sites with multiple locker banks by filtering the multitude of parcel locker banks with the site. However, this selection may not be provided. In act 920, the agent is requested by the Parcel Handling application 430 via the mobile device 420, to specify which activity he wishes to carry out.

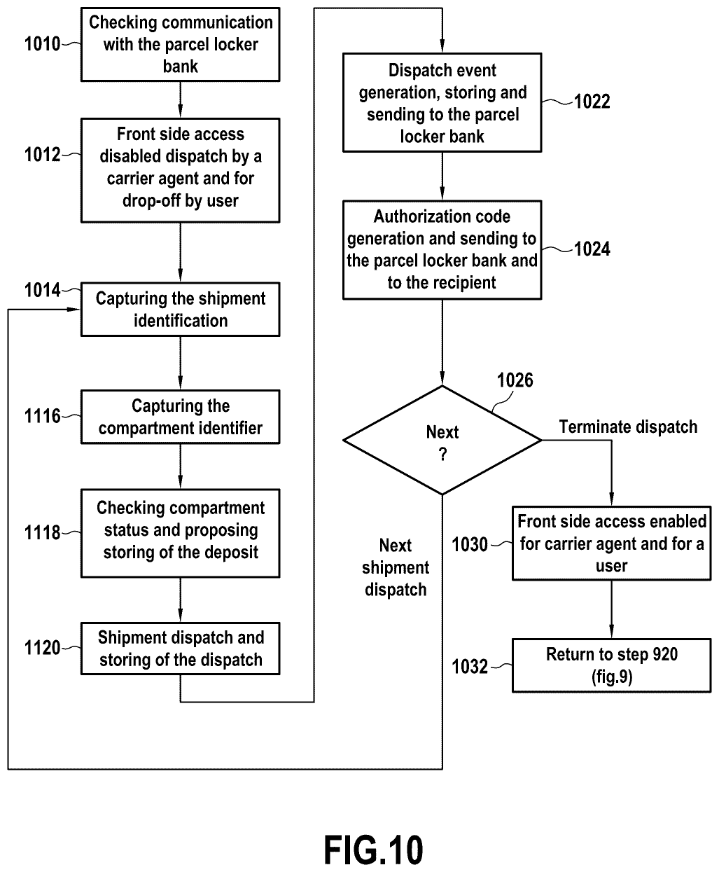

If the agent 406 chooses in act 920 the activity of dispatching shipments into the parcel locker bank, he can carry on according to a method illustrated with FIG. 10 using the mobile device 420 as a local interface for the Parcel Handling application 430 during the whole dispatch process.

In act 1010, the Parcel Handling application checks that the long-distance communication network 422 is operational and that communication with the parcel locker bank is operational otherwise the dispatch process is blocked until communication between the Parcel Handling application 430 and the parcel locker bank 100 or 700 is operational. Communication with the parcel locker bank is required for the Parcel Handling application 430 to be able to deny access to a carrier agent to the front side of the rear-loading control column 118 and of the rear-loading additional columns of the parcel locker bank, and for the Parcel Handling application 430 to be able to synchronize the events generated during the dispatch with the parcel locker bank. This verification is preferable when starting the dispatch process but can be performed later during the dispatch process.

In act 1012, the Parcel Handling application 430 disables access from the front side of the parcel locker bank to compartments of the rear-loading control column 118 and of the rear-loading additional columns 119 for a carrier agent for a dispatch by a carrier agent and for a drop-off by a user (return by a recipient or sending by a sender). Access on the front side of the parcel locker bank is not disabled for a pick-up by a recipient and a recipient can pick-up his shipment during the whole dispatch process on the rear side.

In act 1014, at the request of the Parcel Handling application, the agent captures the identification 132 of the shipment 130. In a preferred embodiment, the agent scans the identification 132 with the scanning component 450 integrated with the mobile device 420. In another embodiment, the agent enters the identification 132 on the user interface of the mobile device 420.

In act 1016, at the request of the Parcel Handling application, the agent captures the locker identifier 220n of the compartment 110n that he chooses in the parcel locker bank for dispatching the shipment 130. In a preferred embodiment, the agent scans the locker identifier 220n with the scanning component 450 integrated with the mobile device 420. In another embodiment, the agent enters the locker identifier 220n on the user interface of the mobile device 420.

In act 1018, the Parcel Handling application acknowledges the capture of the locker identifier 220n and performs multiple verifications on the status of the compartment 110n for allowing the dispatch including whether the compartment 110n is soiled, dysfunctional (for example the electrical lock 114n or a sensor of the compartment 110n does not function), opened (door 112n is opened) or full (logs in the memory system 432 indicates that a shipment is already stored in the compartment 110n), which would result in a non-approval for the dispatch and an error message. If the dispatch is approved, the Parcel Handling application proposes the storing of the dispatch.

In act 1020, the agent dispatches the shipment 130 in the compartment 110n and activates the storing of the dispatch. At the same time, a recipient could have picked-up a second shipment 405 from the front side because the access on the front side of the parcel locker bank is not disabled for a pick-up. The Parcel Handling application stores the captured identification of the shipment 130 and the captured locker identifier 220n in the memory system 432 and performs an association of the captured identification of the shipment 130 and of the captured locker identifier 220n, which is also stored in the memory system 432.

In act 1022, the Parcel Handling application 430 generates events related to the dispatch and stores these events in the memory system 432. Then, the Parcel Handling application provides to the parcel locker bank these events, which are stored in the parcel locker bank memory 410.

In act 1024, the Parcel Handling application 430 generates an authorization code for the recipient to be able later to pick-up the shipment 130 from the compartment 110n. The Parcel Handling application 430 sends the authorization code to the parcel locker bank 100 to be stored in the parcel locker bank memory 410 as the authorization code 414. In parallel, the Parcel Handling application 430 must also send to the recipient the authorization code, therefore called recipient code. The Parcel Handling application 430 may send the recipient code, to the carrier server system 409 because the carrier has a recipient contact information and is generally responsible for providing the recipient with the recipient code. Alternatively, if the parcel locker bank provider has a recipient contact information, which can be stored in the memory system 432, the Parcel Handling application sends the recipient code directly to the recipient, for example by mail and/or by SMS.

In act 1026, the Parcel Handling application proposes the possibilities for another shipment dispatch or for terminating the dispatch process. If the agent chooses to dispatch another shipment, the dispatch process resumes in act 1014 where, at the request of the Parcel Handling application, the agent captures the identification of another shipment.

If the agent chooses to terminate the dispatch process, the dispatch process proceeds in act 1030, the Parcel Handling application enables access from the front side of the parcel locker bank to compartments of the rear-loading control column 118 and of the rear-loading additional columns for a carrier agent and for a user (recipient or sender).

In act 1032, the Parcel Handling application resumes in act 920, where the agent is requested by the Parcel Handling application which activity he wishes to carry out.

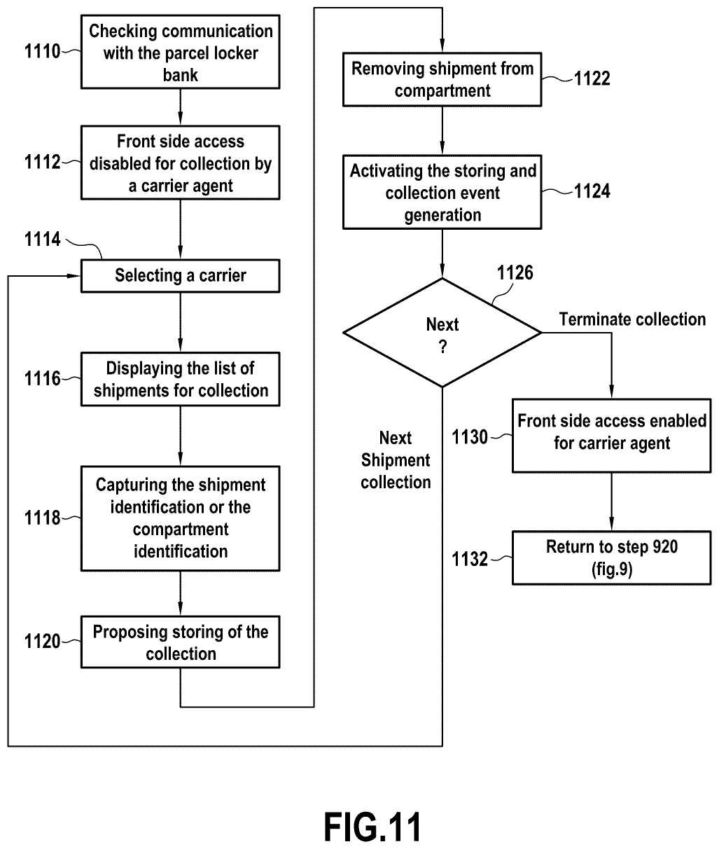

If the agent 406 chooses in act 920 the activity of collecting shipments from the parcel locker bank, he can carry on according to a method illustrated with FIG. 11 using the mobile device 420 as a local interface for the Parcel Handling application 430 during the whole collection process.

In act 1110, the Parcel Handling application checks that the long-distance communication network 422 is operational and that communication with the parcel locker bank is operational otherwise the collection process is blocked until communication between the Parcel Handling application and the parcel locker bank is operational. Communication with the parcel locker bank is required for the Parcel Handling application to be able to disable for a carrier agent access from the front side of the parcel locker bank to compartments of the rear-loading control column 118 and to compartments of the rear-loading additional columns and for the Parcel Handling application to be able to synchronize the events generated during the collection with the parcel locker bank. This check is preferable when starting the collection process but can be performed later during the collection process.

In act 1112, the Parcel Handling application disables access from the front side of the parcel locker bank to compartments of the rear-loading control column 118 and to compartments of the rear-loading additional columns for a collection by a carrier agent. Access on the front side of the parcel locker bank is not disabled for a pick-up by a recipient and a recipient can pick-up his shipment during the whole collection process on the rear side.

In act 1114, at the request of the Parcel Handling application, the agent selects a carrier within the list of carriers 438 stored in the memory system 432 and proposed by the Parcel Handling application. A list of shipments for collection corresponds to each carrier. Based on this list, the agent can collect and group all the shipments for collection for that particular carrier, so that it can be handled as a group by that carrier.

In act 1116, the Parcel Handling application displays a list of shipments for collection stored in the memory 440 and corresponding to the selected carrier.

In act 1118, at the request of the Parcel Handling application, the agent captures the identification 132 of the shipment 130 that he needs to collect. In a preferred embodiment, the agent scans the identification 132 with the scanning component 450 integrated with the mobile device 420. In another embodiment, the agent enters the identification 132 on the user interface of the mobile device 420. The Parcel Handling application can also propose as an alternative the capture of the locker identifier 220n (aka compartment identifier) of the compartment 110n where the shipment 130 is stored. The agent can then capture the compartment identifier 220n of the compartment. In a preferred embodiment, the agent scans the locker identifier 220n with the scanning component 450 integrated with the mobile device 420. In another embodiment, the agent enters the locker identifier 220n on the user interface of the mobile device 420. Only either the capture of the identification 132 of the shipment or the capture of the locker identifier 220n is required as these two pieces of information have been associated during the dispatch process.

In act 1120, the Parcel Handling application acknowledges the capture of the identification 132 or of the locker or compartment identifier 220n and proposes the storing of the collection.

In act 1122, the agent removes the shipment 130 from the compartment. As the access from the front side of the parcel locker bank is not disabled for a pick-up, a recipient of the shipment 130 can pick-up the shipment 130 from the front side. If the recipient tries at the same time to pick-up the parcel 130 from the compartment 110n, the agent lets the receiver pick-up the parcel and resumes in act 1116 if he wants to collect another shipment or proceeds to act 1130 if he wishes to terminate the collection process. Following on the pick-up of the shipment 130 by the recipient, the shipment 130 is not displayed anymore by the Parcel Handling application in the list of shipments for collection.

In act 1124, the agent activates the storing of the collection. The Parcel Handling application 430 removes the collected shipment 130 from the list of shipments for collection stored in the memory 440 or attributes a collected status to the shipment, and generates an event related to the collection, and stores the event in the memory system 432. Then, the Parcel Handling application provides to the parcel locker bank this event, which is stored in the parcel locker bank memory 410.

In act 1126, the Parcel Handling application proposes the possibilities for another shipment collection or for terminating the collection process. If the agent chooses to collect another shipment for the same selected carrier, the collection process resumes in act 1116 where the Parcel Handling application displays the list of shipments for collection and corresponding to the selected carrier (without the shipment 130 just collected). If the agent chooses to collect another shipment for a different carrier than the selected carrier, the collection process resumes in act 1114 where, at the request of the Parcel Handling application, the agent selects a carrier.

If the agent chooses to terminate the collection process, the collection process proceeds in act 1130, the Parcel Handling application enables access from the front side of the parcel locker bank to compartments of the rear-loading control column 118 and of the rear-loading additional columns for a carrier agent.

In act 1032, the Parcel Handling application resumes in act 920, where the agent is requested by the Parcel Handling application which activity he wishes to carry out.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via one or more computers, processor-based systems, and/or processors (e.g., microprocessors, microcontrollers, central processing units (CPUs), digital signal processors (DSPs), graphics processing units (GPUs), application specific integrated circuits (ASICs), field programmable gate arrays (FPGA), along with nontransitory storage media (e.g., non-volatile memory, volatile memory, read only memory (ROM), random access memory (RAM), FLASH memory, EEPROM, registers, magnetic disk drives, optical disk drives, solid state drives), and/or communications subsystems (e.g., radios, transmitters, receivers and associated antennas, wired and/or optical communications ports and associated drivers or modems). Those skilled in the art will recognize that the parcel locker banks can include one or more processors, nontransitory storage media, communications subsystems. Those skilled in the art will recognize that the parcel locker banks can include one or more actuators (e.g., electric motor, solenoid, pneumatic or hydraulic cylinder, piston and valves, electromagnets, latches and/or locks, which are operable to unlock and/or open a parcel locker door and/or lock or close a parcel locker door of a parcel locker bank, for example in response to signals from the processor(s). Those skilled in the art will recognize that the parcel locker banks, and even individual parcel lockers can include one or more, sensors (e.g., sensor to detect state or position of a door, sensor to detect when locker compartment is occupied or emptied), for example a PIR sensor, a weight sensor or load cell, a Reed switch, a contact sensor or switch, position sensor, pressure sensor, temperature sensor, force sensor, IR transmitter receiver pair, etc. The sensors can be communicatively coupled to the one or more processors to provide information or data thereto, which the processor(s) can use to control operation of the parcel locker bank, parcel lockers, or interact with servers and/or with mobile communications devices (e.g., users smartphones or tablet computers). Those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

The various embodiments described above can be combined and/or modified to provide further embodiments in light of the above-detailed description, including the material incorporated by reference. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A parcel locker bank system for dispatching and collecting shipments by an agent, such as a carrier agent, as well as for dropping-off and picking-up of shipments by a user, the parcel locker bank system including:
a bank of lockers comprising a front side, a rear side, a control unit, a user interface facing towards the front side of the bank, and several lockers extending each between said front side and said rear side of the bank and each configured to store a shipment, each locker comprising a compartment opened on the rear side of the bank, closed on the front side of the bank by an individual electronically controlled door,
a remote shipping system comprising a Parcel Handling application and communicating with the bank via a first long-distance communication network, and with a mobile device of the agent via a second long-distance communication network,
characterized in that the compartment of each locker is opened on the rear side of the bank, the bank being designed to give access to its rear side only to the agent while access to its front side is given to both the user and the agent,
in that the control unit is configured to open the doors on the front side of the bank to allow dispatching, collecting, dropping-off and picking-up the shipments, and
the Parcel Handling application is configured to send data to the mobile device of the agent to guide him through the dispatching and collecting of shipments from the rear side and to receive data from the mobile device of the agent to verify that the agent has made no mistake in dispatching and collecting.

2. The parcel locker bank system according to claim 1, wherein the Parcel Handling application is configured for the dispatch or the collection of a first shipment on the rear side of the bank during a pick-up of a second shipment from the front side of the parcel locker bank.

3. The parcel locker bank system according to claim 1, wherein the Parcel Handling application is configured to disable access to the lockers from the front of the bank for a dispatch by a carrier agent or for a drop-off by the user while a shipment is being dispatched in the locker from the rear of the bank, and to disable access to the lockers from the front side of the bank for a collection of a shipment by a carrier agent while a shipment is being collected from the rear of the bank.

4. The parcel locker bank system according to claim 1, wherein a locker identifier is attached onto or next to the locker and an identification label of the shipment is attached to the shipment, the Parcel Handling application being configured to request and receive from the mobile device of the agent a capture of the identification label and of the locker identifier, to store the capture of the identification label of the shipment in a first memory space of the remote shipping system and store the locker identifier in a second memory space of the remote shipping system, and to associate the first memory space with the second memory space, the mobile device of the agent comprising or being associated with a scanning component and is configured to use the scanning component for capturing identification labels and locker identifiers.

5. The parcel locker bank system according to claim 1, wherein the Parcel Handling application is configured to generate an authorization code further to a dispatch of a shipment in the rear side of a locker of the bank, and send the authorization code to the control unit of the bank for storage in a local memory, the control unit being configured to grant access to a user to said locker to pick-up the shipment by comparing the authorization code stored in the local memory with credential provided by the user.

6. The parcel locker bank system according to claim 1, wherein the mobile device of the agent is configured to establish a communication with the remote shipping system and the Parcel Handling application is configured to exchange in real time with the mobile device of the agent through the first long-distance communication network while shipments are being dispatched and/or collected from the rear side of the bank.

7. The parcel locker bank system according to claim 1, wherein the bank comprises at least one standard locker equipped with an electronically controlled door attached on the front side of the bank and closed by a rear panel on the rear side of the bank, the standard locker being used for dispatching, collecting, dropping-off and picking-up shipments only from the front side of the bank, the Parcel Handling application being configured to always allow access to the standard locker from the front side of the bank while shipments are being dispatched and or collected from the rear side of the bank.

8. The parcel locker bank system according to claim 7, wherein the bank (100, 700) comprises:
a rear-loading column with at least one locker opened on the rear side of the bank,
a rear-loading control column including the control unit and the user interface and at least one locker opened on the rear side of the bank, and
a standard column with at least one standard locker closed on the rear side of the bank by a rear panel,
the rear side of the bank of lockers being closed by at least one rear-side door, said rear-side door having dimensions allowing to close at least two lockers on the rear side of the bank.

9. A method using a parcel locker bank for dispatching, collecting, dropping-off and picking-up shipments, wherein the parcel locker bank has a front side and a rear side and comprises a user interface and at least a locker equipped with an electronically controlled door attached on the front side of the bank and opened on the rear side of the bank to provide access for dispatching and a collecting shipments from the rear side of the bank, wherein the parcel locker bank communicates with a remote shipping system via a first long-distance communication network and the remote shipping system communicates with a mobile device via second a long-distance communication network, wherein the parcel locker bank controls a dispatch, a collection, a drop-off or a pick-up on the front side by an agent or a user using the user interface for interacting with the lockers of the bank, and wherein the remote shipping system partially controls the parcel locker bank and manages the dispatch or the collection from the rear side of the bank by an agent via the mobile device.

10. The method according to claim 9, the method comprising:
choosing to dispatch the first shipment from the rear side of the bank using the mobile device as a local interface for the remote shipping system, and
dispatching the first shipment on the rear side of the parcel locker bank while picking-up a second shipment from the front side of the parcel locker bank.

11. The method according to claim 10, further comprising disabling access to the locker from the front side of the parcel locker bank for a dispatch by a carrier agent and for a drop-off by a user when dispatching the shipment from the rear side of the parcel locker bank.

12. The method according to claim 10, further comprising:
capturing an identification label of the shipment, and
capturing a locker identifier of the locker
dispatching, from the rear side of the bank, the shipment in the locker,
storing the captured identification label of the shipment and the captured locker identifier in the remote shipping system,
associating the stored identification label of the shipment and the stored locker identifier,
following the capture of the identification of the shipment and the capture of the locker identifier, verifying whether a status of the locker is non-acceptable, including non-acceptable status for being soiled or dysfunctional or opened or full,
if the status of the locker is not non-acceptable, proposing on the mobile device to dispatch the shipment and store the dispatch, before completing the dispatch of the shipment, and
if the status of the locker is non-acceptable, displaying an error on the mobile device.

13. The method according to claim 9, further comprising:
following on the dispatch of the shipment, generating by the remote shipping system an authorization code to be used by a recipient of the shipment for picking-up the shipment from the locker,
sending the authorization code to the parcel locker bank,
storing the authorization code in the parcel locker bank, and
validating an access request from the user based on the authorization code stored in the parcel locker bank.

14. The method according to claim 9, further comprising:
choosing to collect from the rear side of the bank a first shipment from the locker using the mobile device as a local interface for the remote shipping system, and
picking-up from the front side of the bank a second shipment of the parcel locker bank while collecting the first shipment from the rear side of the parcel locker bank, and
disabling access from the front of the parcel locker bank to the locker for a collection by an agent during a collection of a shipment from the rear side of the parcel locker bank.

15. The method according to claim 13, further comprising:
selecting a carrier within a list of carriers displayed on the mobile device and stored in the remote shipping system,
displaying on the mobile device a list of shipments to collect stored in the remote shipping system and corresponding to the selected carrier,
capturing an identification label of the shipment to be collected,
or alternatively capturing a locker identifier,
removing the shipment from the locker, and
stopping displaying the shipment in the list of shipments for collection on the mobile device.
